(19) United States
(12) Patent Application Publication
(10) Pub. No.: US 2025/0317081 A1
(43) Pub. Date: Oct. 9, 2025

(54) STEPPER MOTOR CONTROL METHOD AND APPARATUS WITH REDUCED VIBRATION DURING ACCELERATION AND DECELERATION

(71) Applicant: AMO Development, LLC, Irvine, CA (US)

(72) Inventors: Michael Simoneau, Morgan Hill, CA (US); Danielle Croft, Notre Dame, IN (US)

(21) Appl. No.: 18/923,588

(22) Filed: Oct. 22, 2024

Related U.S. Application Data
(60) Provisional application No. 63/631,926, filed on Apr. 9, 2024.

(51) Int. Cl. H02P 8/32; H02P 8/08; H02P 8/34

(52) U.S. Cl. CPC H02P 8/32; H02P 8/08; H02P 8/34

(57) ABSTRACT

A stepper motor control method and related control circuitry (for example, an FPGA) to control the acceleration and/or deceleration of the stepper motor movement to reduce system vibration. Acceleration and deceleration are implemented by adjusting the stepper motor period (the time between consecutive stepper motor position) based on the distance from the start or to the end position. The closer to the start or end position, the longer the period employed. In the middle range of its travel, the motor speed is constant and the stepper motor period is the shortest. The stepper motor period is always a nominal period multiplied by a factor of 2\hat{ }n, where n is zero or a positive integer. The resulting motor position vs. time curve is an approximated S-curve. The acceleration and deceleration control minimizes mechanically induced vibrations, while reducing implementation complexity and demand on FPGA resources.

### CROSS-REFERENCE TO RELATED APPLICATIONS

This application claims priority to U.S. Provisional Application No. 63/631,926, filed Apr. 9, 2024, the entire contents of which are hereby incorporated by reference in its entirety.

### BACKGROUND OF THE INVENTION

This invention relates to a stepper motor control method and apparatus, and in particular, it relates to a stepper motor control method and apparatus that achieve reduced vibration in the stepper motor response during acceleration and/or deceleration.

A stepper motor is an electric motor that is controlled to rotate in small steps. The speed of the motor may be controlled by controlling the stepper motor period, i.e., the time period between consecutive movement steps. Stepper motor position control systems without position feedback often execute position changes by moving the motor one step at a time until a final position is achieved. This is a simple approach that is easy to implement in low level embedded hardware control such as field programmable gate arrays (FPGAs). However, the jerk induced by high acceleration and deceleration at the start and end of the move can cause undesirable mechanical vibration in the system.

A conventional approach to reducing vibration in such a system is implementation of an S-curve, in which the acceleration at the start and end of the move is increased and decreased slowly, respectively. In this way the mechanical vibration is reduced. The standard S-curve approach employs an exponential function, referred to as the sigmoid function:

S(x)=1/(1+e\hat{ }−x),
which has a characteristic S shaped curve (sigmoid curve). This function is difficult to implement for FPGA execution, and consumes large amounts of resources (FPGA fabric), whether implemented by direct calculation of the exponential function, or by use of a look-up table. In applications where FPGA resources are limited, this is undesirable.

### SUMMARY OF THE INVENTION

Accordingly, the present invention is directed to a method and related apparatus of stepper motor control that substantially obviates one or more of the problems due to limitations and disadvantages of the related art.

An object of the present invention is to provide a stepper motor control method that implements a simpler approximation of the S-curve during acceleration and/or deceleration, which is particularly suitable in applications with limited resources and/or computational power.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve the above objects, the present invention provides a method for controlling a stepper motor, which includes: defining a start position or a commanded target position of the stepper motor; and by a logic circuit, controlling the stepper motor to move away from the start position or toward the commanded target position in a plurality of steps, wherein a time period between each current step and its next step is a function of a distance from the start, which is a distance between the start position and a current position of the stepper motor, or a distance to target, which is a distance between the current position of the stepper motor and the commanded target position, wherein the time period is a pre-set time period multiplied by 2\hat{ }n, where n is zero or a positive integer.

In another aspect, the present invention provides a logic circuit for controlling a stepper motor, which includes: a field programmable gate array (FPGA) programed to: receive a commanded target position of the stepper motor and a pre-set time period value; and generate control signals to move stepper motor to move toward the commanded target position in a plurality of steps, wherein a time period between each current step and its next step is a function of a distance from the start, which is a distance between the start position and a current position of the stepper motor, or a distance to target, which is a distance between the current position of the stepper motor and the commanded target position, wherein the time period is a pre-set time period multiplied by 2\hat{ }n, where n is zero or a positive integer.

In another aspect, the present invention provides a method for controlling a stepper motor, which includes: defining a commanded target position of the stepper motor; and by a logic circuit, controlling the stepper motor to move toward the commanded target position in a plurality of steps, including: (a) initializing a variable n to a value of zero; (b) determining a current position of the stepper motor; (c) determining a distance to target, which is a distance between the current position and the commanded target position of the stepper motor, wherein the distance to target is defined in step counts of the stepper motor; (d) if the distance to target is not less than 2\hat{ }(D−n), where D is a constant parameter, maintaining the value of n, and if the distance to target is less than 2\hat{ }(D−n), incrementing the value of n by 1; (e) setting a time period to a pre-set time period multiplied by 2\hat{ }n; (f) after waiting the time period, moving the stepper motor by one step; and (g) repeating steps (b) through (f) until the commanded target position is reached.

In another aspect, the present invention provides a method for controlling a stepper motor, which includes: defining a start position of the stepper motor; and by a logic circuit, controlling the stepper motor to move away from the start position in a plurality of steps, including: (a) initializing a variable n to a value that equals A, where A is a constant parameter; (b) determining a current position of the stepper motor; (c) determining a distance from start, which is a distance between the start position and the current position of the stepper motor, wherein the distance from start is defined in step counts of the stepper motor; (d) if the distance from start is not greater than 2\hat{ }(A−n), maintaining the value of n, and if the distance from start is greater than 2\hat{ }(A−n), decrementing the value of n by 1; (e) setting a time period to a pre-set time period multiplied by 2\hat{ }n; (f) after waiting the time period, moving the stepper motor by one step; and (g) repeating steps (b) through (f) until n equals zero.

In another aspect, the present invention provides a logic circuit for controlling a stepper motor, which includes a field programmable gate array (FPGA) programed to perform the above methods.

It is to be understood that both the foregoing general description and the following detailed description are exemplary and explanatory and are intended to provide further explanation of the invention as claimed.

### BRIEF DESCRIPTION OF DRAWINGS

FIG. 1 is a flow chart that illustrates a stepper motor control method during deceleration according to an embodiment of the present invention.

FIG. 2 is a flow chart that illustrates a stepper motor control method during acceleration according to an embodiment of the present invention.

FIG. 3 is a diagram showing an implementation of the stepper motor control method of FIG. 1 (deceleration) programmed in a LabVIEW™ programming environment for execution on an FPGA.

FIG. 4 shows examples of the behavior of a rotary stepper motor when a deceleration control method according to an embodiment of the present invention is implemented.

FIGS. 5A and 5B show examples of measured mechanical vibration in a stepper motor system near the end position, without (FIG. 5A) and with (FIG. 5B) deceleration control applied.

FIG. 6 is a block diagram showing a pulsed laser system including a stepper for laser pulse energy control, in which embodiments of the present invention may be implemented.

FIG. 7 is a schematic block diagram showing a stepper motor and a controlled including an FPGA, in which embodiments of the present invention may be implemented.

### DETAILED DESCRIPTION OF THE INVENTION

Embodiments of the present invention provide a stepper motor control method and related control circuitry (for example, an FPGA) to control the stepper motor to move from a start position, where the motor is stationary, to an end position, where it comes to a stop. The method implements an acceleration at the start of a move, and/or a deceleration at the end of the move, that reduce system vibration in a manner that is relatively easy to implement in FPGA code and uses less FPGA resources than conventional S-curve algorithms.

Acceleration and deceleration are implemented by adjusting the stepper motor period (the time between consecutive stepper motor position) based on the distance from the start or end position. The closer to the start or end position, the longer the period employed. In the middle range of its travel, the motor speed is constant and the stepper motor period is the shortest. The stepper motor period is always a nominal period multiplied by a factor of 2\hat{ }n, where n is zero or a positive integer. The goal is to gently increase acceleration at the start of a move, and/or gently decrease it at the end of the move, to minimize mechanically induced vibrations, while reducing implementation complexity and demand on FPGA resources.

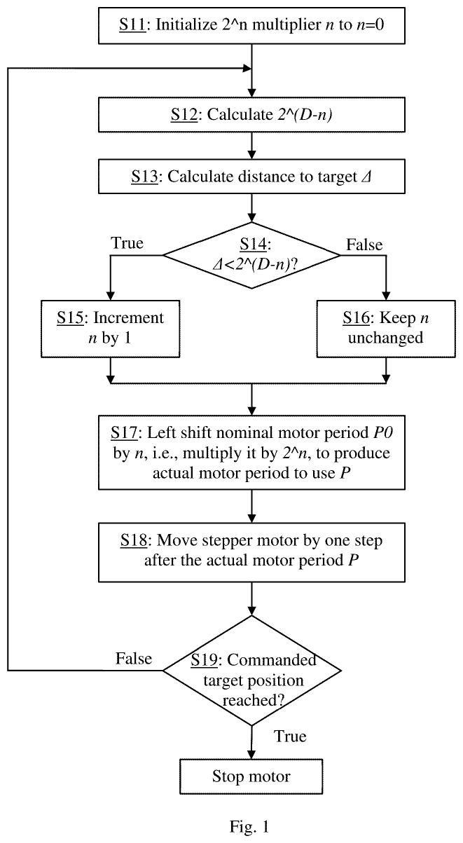

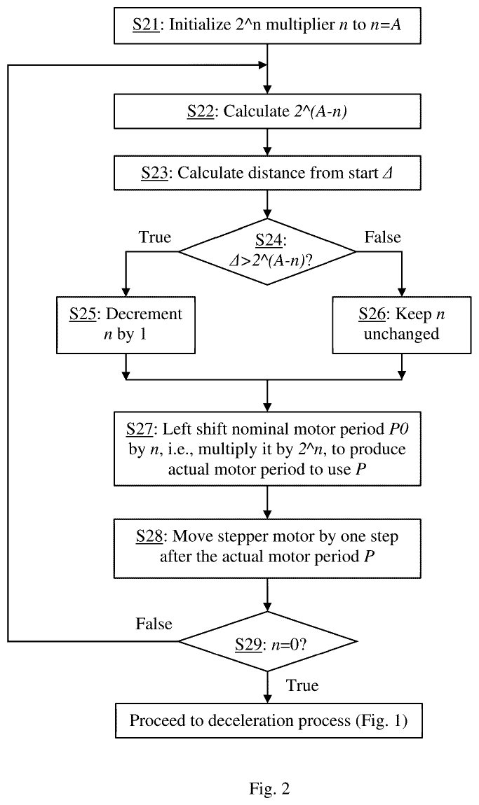

FIGS. 1 and 2 schematically illustrate a stepper motor control method, where FIG. 1 illustrates the deceleration process and FIG. 2 illustrates the acceleration process. The control method is implemented in a controller, which is preferably an FPGA. The acceleration and deceleration algorithms are inserted into the stepper motor control loop before the motor driver circuit, to adjust the stepper motor period.

The method has the following input parameters that can be set by an operator:

(1) Commanded end position (expressed in stepper motor step count). The start position is known.

(2) Nominal motor period (P0): The nominal or default time between consecutive steps of the stepper motor movement. It may be expressed in FPGA clock ticks, where 1 tick=25 nsec or other suitable values. This is the motor period during the middle range of the travel when the motor is neither accelerating nor decelerating. In the examples described here, it is assumed that such a constant-speed middle range is reached during the move. Note that for some combinations of parameters, it is possible for the motor to not yet reach this constant speed before deceleration starts.

(3) Acceleration factor (A) and deceleration factor (D): Unitless factors (preferably integers) that control the rate of acceleration and deceleration, respectively. They may be the same or different in values.

(4) Disable flag: A Boolean control that may be used to turn off deceleration. This may be useful, for example, when the position command changes during execution of a move. This parameter is optional.

The values calculated by the control method during motor movement include:

(5) Distance from start and distance to target (Δ): The difference between the current motor position and the start position, and the difference between the current motor position and the commanded end position, respectively (expressed in step counts).

(6) Motor period to use (P): The actual motor period to be used for the next step (i.e. the step that moves from the current motor position to the next position) (expressed in FPGA clock ticks).

(7) 2\hat{ }n Multiplier (n): A multiplier used to adjust the actual motor period by a factor of 2\hat{ }n (1, 2, 4, 8, etc.) to implement acceleration and deceleration. n is zero or a positive integer.

The algorithm for deceleration, from a state when the stepper motor is moving at a constant speed where the motor period is the nominal motor period (P0), is as follows (refer to FIG. 1).

Prior to executing this process, the requisite parameters have been received as input: commented end position, nominal motor period P0, deceleration factor D, and disable flag (optional). This process is executed when the motor is moving at the constant speed corresponding to the nominal motor period P0. In an exemplary embodiment, D=8.

At the beginning of the deceleration process, the 2\hat{ }n multiplier n is initialized to n=0 (step S11). To control the move from the current motor position to the next position, the controller first subtracts the previous 2\hat{ }n multiplier n from the deceleration factor D, and calculates a value 2\hat{ }(D−n) (step S12). Here, “previous” refers to the n value used for the previous motor step. The distance to target Δ, i.e., from the current motor position to the commanded target position, is also calculated (step S13). If the distance to target Δ is less than the value 2\hat{ }(D−n), the 2\hat{ }n multiplier n is incremented by 1, otherwise it is unchanged (steps S14, S15, S16). The nominal motor period P0 is then left shifted by the resulting 2\hat{ }n multiplier n to give the actual motor period to use P for the next motor step (step S17). Note that the left shift by n is a binary operation which is equivalent to multiplication by 2\hat{ }n. The motor is moved one step after the calculated actual motor period P (step S18), and the process repeats steps S12-S18 for the next motor step, until the commanded target position is reached (step S19) when the motor stops.

As a result, the motor moves at full speed corresponding to the nominal motor period P0 until the distance to target Δ reaches 2\hat{ }D. As the stepper motor approaches the target position, i.e., the distance to target Δ decreases progressively to below 2\hat{ }D, below 2\hat{ }(D−1), below 2\hat{ }(D−2), . . . , the 2\hat{ }n multiplier n will gradually increase, causing the time between steps (the actual motor period to use P) to increase, and the stepper motor to decelerate.

Note that if the deceleration factor D is set to 0, the distance to target Δ will never decreases to below 2\hat{ }D=1 before the target position is reached, so the actual motor period P will never be increased, and the motor will operate as if no deceleration is applied, i.e., it will move at full speed corresponding to the nominal motor period P0 until it stops at the target position.

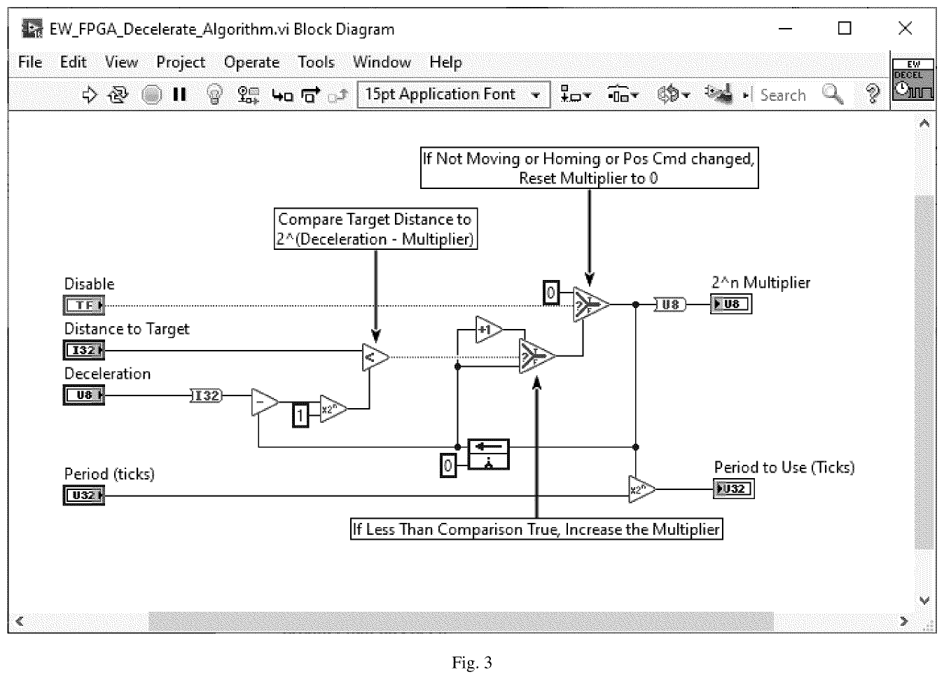

In a particular embodiment, the deceleration process is programmed in a LabVIEW™ programming environment for execution on an FPGA, as shown in FIG. 3.

The algorithm for acceleration from the start position (when the stepper motor is stationary) to a constant full speed where the actual motor period is the nominal motor period P0, is as follows (refer to FIG. 2).

Prior to executing this process, the requisite parameters have been received as input: nominal motor period P0, acceleration factor A, and disable flag (Optional). The start position is known. In an exemplary embodiment, A=8.

At the beginning of the acceleration process, the 2\hat{ }n multiplier n is initialized to n=A (step S21). To control the move from the current motor position to the next position, the controller first subtracts the previous 2\hat{ }n multiplier n from the acceleration factor A, and calculates a value 2\hat{ }(A−n) (step S22). Here, “previous” refers to the n value used for the previous motor step (or the initial n for the first step). The distance from start 4, i.e., between the current motor position and the start position, is also calculated (step S23). If the distance from start 4 is greater than the value 2\hat{ }(A−n), the 2\hat{ }n multiplier n is decremented by 1, otherwise it is unchanged (steps S24, S25, S26). The nominal motor period P0 is then left shifted by the resulting 2\hat{ }n multiplier n (i.e., multiplied by 2\hat{ }n) to give the actual motor period to use P for the next motor step (step S27). The motor is moved one step after the calculated actual motor period P (step S28). The process repeats steps S22-S28 for the next step, until n=0 when the motor reaches the full speed corresponding to the nominal motor period P0 (step S29). At this time, the deceleration process (FIG. 1) may be executed.

As a result, as the stepper motor starts from the start position, the 2\hat{ }n multiplier n will gradually decrease from A to 0, causing the time (actual motor period P) between steps to decrease, and the stepper motor to accelerate. When the distance from start increases to above 2\hat{ }A, the motor reaches the full speed corresponding to the nominal motor period P0 and remains at that constant speed, until it is sufficiently close to the target position and deceleration begins.

Note that if the acceleration factor A is set to 0, n will be initialized to 0 and the motor will operate as if no acceleration is applied, i.e., it will move at full speed corresponding to the nominal motor period P0 from the first step on.

To summarize, the above described acceleration and deceleration functions continuously adjusts the stepper motor period by a factor of 2\hat{ }n, where n is smaller (or zero) when the stepper motor is far away from the start and target positions, and larger when the motor is close to the start and target positions. During acceleration and deceleration, the motor period to use P is always the nominal motor period P0 multiplied by a factor of 2\hat{ }n, where n is 0 or a positive integer. As the most complex functions in this algorithm are subtraction and 2\hat{ }n multiplication (i.e. binary left shift), this algorithm is easy to implement in FPGA code and uses less FPGA resources.

The acceleration control process and the deceleration control process described above may be applied independently of each other, i.e., for a given stepper motor move, either the acceleration control, or the deceleration control, or both, may be applied. This may be accomplished by setting either the acceleration factor A or the deceleration factor D to 0. In some stepper motor systems, acceleration from start may induce less vibration than deceleration at the end, and it may be practical to apply only the deceleration control method.

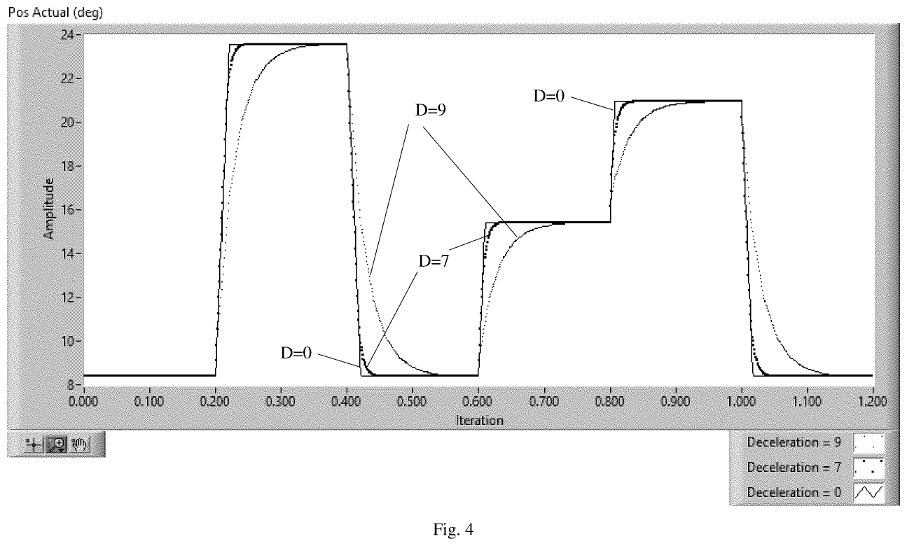

FIG. 4 shows a simulation of the behavior (position vs. time) of an actual rotary stepper motor with 12800 steps per revolution and a maximum velocity of 720 deg/sec for deceleration values D of 9, 7, and 0. The default period in this case is 1562 ticks, or 39.050 μsec. In each of these examples, five moves of the stepper motor are shown. Note that in these examples, no acceleration control is applied. It can be seen that the motor position is an approximate S-curve, although only a half of the approximate S-curve is seen due to the absence of acceleration control.

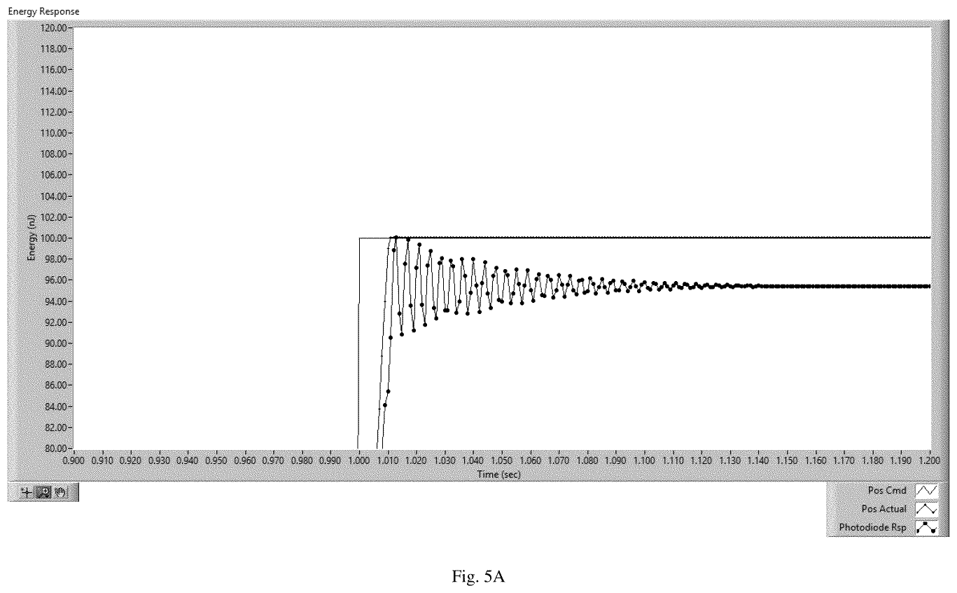

FIG. 5A shows an example of measured mechanical vibration in a stepper motor system near the target position, with no deceleration control applied. The line labelled Photodiode Rsp represents actual system vibration picked up by a photodiode. FIG. 5B shows an example of measured mechanical vibration in the stepper motor system near the target position, with deceleration control according to an embodiment of the present invention applied (D=9 in this example). The trace labelled Photodiode Rsp represents actual system vibration picked up by a photodiode. It can be seen that in FIG. 5B, system vibration is significantly reduced with the implementation of deceleration control.

In alternative embodiments, by adding more resolution to the values of the acceleration factor A, deceleration factor D and 2\hat{ }n multiplier n, e.g., by using fixed-point values in place of integers, more granularity of control over the response of the stepper motor system may be obtained.

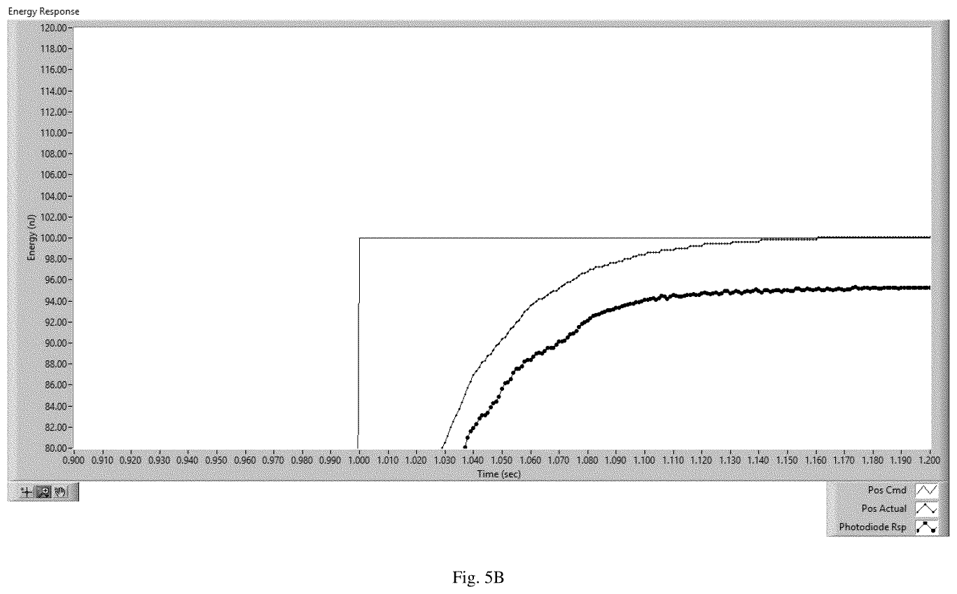

FIG. 6 is a block diagram of a pulsed laser system including a stepper for laser pulse energy control, in which embodiments of the present invention may be implemented. The stepper motor is used in an energy control subsystem of the laser system. The energy control subsystem includes a half-wave plate HWP and a polarization beam splitter PBS. An energy wheel EW rotates the half-wave plate HWP, the position of which, in combination with the polarization beam splitter PBS, controls the output laser energy. The energy wheel EW is moved by the stepper motor from one position to another to adjust the output energy. The energy control subsystem includes other components such as a beam dumper, a beam splitter BS1 that delivers portions of the laser beam to a dual channel energy monitor D1, D2 and an auto-Z detector, a laser shutter, and another beam splitter BS2 that delivers a portion of the beam to a shutter leakage detector.

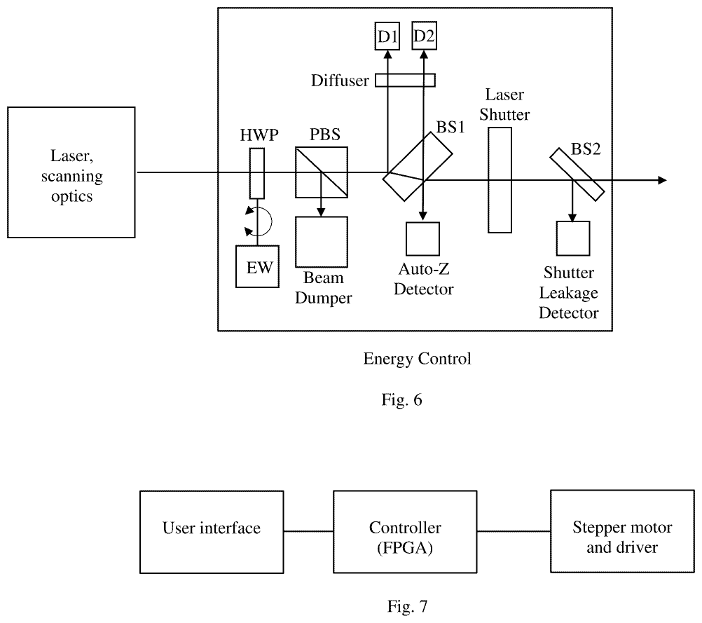

It should be emphasized that the present invention is not limited to control of an energy wheel in a laser system, but is applicable to any stepper motor control system (see, e.g., FIG. 7) that is implemented by controlling the period between steps.

It will be apparent to those skilled in the art that various modification and variations can be made in the stepper motor control method and related apparatus of the present invention without departing from the spirit or scope of the invention. Thus, it is intended that the present invention cover modifications and variations that come within the scope of the appended claims and their equivalents.

1. A method for controlling a stepper motor, comprising:
defining a start position or a commanded target position of the stepper motor; and
by a logic circuit, controlling the stepper motor to move away from the start position or toward the commanded target position in a plurality of steps,
wherein a time period between each current step and its next step is a function of a distance from the start, which is a distance between the start position and a current position of the stepper motor, or a distance to target, which is a distance between the current position of the stepper motor and the commanded target position, wherein the time period is a pre-set time period multiplied by 2\hat{ }n, where n is zero or a positive integer.

2. The method of claim 1, wherein the distance from start or the distance to target is defined in step counts of the stepper motor.

3. The method of claim 2, wherein when the distance from start is less than a pre-set threshold value, n decreases as the distance to target increases, and n equals zero when the distance from start is not less than the pre-set threshold value.

4. The method of claim 3, wherein the pre-set threshold value is 2\hat{ }A, where A is a constant parameter, and when the distance from start not less than 2\hat{ }(A−n) but is less than 2\hat{ }(A−n+1), the time period is the pre-set time period multiplied by 2\hat{ }(n−1).

5. The method of claim 2, wherein n equals zero when the distance to target is not less than a pre-set threshold value, and when the distance to target is less than the pre-set threshold value, n increases as the distance to target decreases.

6. The method of claim 5, wherein the pre-set threshold value is 2\hat{ }D, where D is a constant parameter, and when the distance to target is less than 2\hat{ }(D−n) and not less than 2\hat{ }(D−n−1), the time period is the pre-set time period multiplied by 2\hat{ }(n+1).

7. The method of claim 1, wherein each time period is defined in clock cycles of the logic circuit.

8. The method of claim 1, wherein the logic circuit is a field programmable gate array (FPGA).

9. A method for controlling a stepper motor, comprising:
defining a commanded target position of the stepper motor; and
by a logic circuit, controlling the stepper motor to move toward the commanded target position in a plurality of steps, including:
(a) initializing a variable n to a value of zero;
(b) determining a current position of the stepper motor;
(c) determining a distance to target, which is a distance between the current position and the commanded target position of the stepper motor, wherein the distance to target is defined in step counts of the stepper motor;
(d) if the distance to target is not less than 2\hat{ }(D−n), where D is a constant parameter, maintaining the value of n, and if the distance to target is less than 2\hat{ }(D−n), incrementing the value of n by 1;
(e) setting a time period to a pre-set time period multiplied by 2\hat{ }n;
(f) after waiting the time period, moving the stepper motor by one step; and
(g) repeating steps (b) through (f) until the commanded target position is reached.

10. The method of claim 9, wherein the time period is defined in clock cycles of the logic circuit.

11. The method of claim 9, wherein the logic circuit is a field programmable gate array (FPGA).

12. A method for controlling a stepper motor, comprising:
defining a start position of the stepper motor; and
by a logic circuit, controlling the stepper motor to move away from the start position in a plurality of steps, including:
(a) initializing a variable n to a value that equals A, where A is a constant parameter;
(b) determining a current position of the stepper motor;
(c) determining a distance from start, which is a distance between the start position and the current position of the stepper motor, wherein the distance from start is defined in step counts of the stepper motor;
(d) if the distance from start is not greater than 2\hat{ }(A−n), maintaining the value of n, and if the distance from start is greater than 2\hat{ }(A−n), decrementing the value of n by 1;
(e) setting a time period to a pre-set time period multiplied by 2\hat{ }n;
(f) after waiting the time period, moving the stepper motor by one step; and
(g) repeating steps (b) through (f) until n equals zero.

13. The method of claim 12, wherein the time period is defined in clock cycles of the logic circuit.

14. The method of claim 12, wherein the logic circuit is a field programmable gate array (FPGA).

15. A logic circuit for controlling a stepper motor, comprising:
a field programmable gate array (FPGA) programed to:
receive a commanded target position of the stepper motor and a pre-set time period value; and
generate control signals to move stepper motor to move toward the commanded target position in a plurality of steps,
wherein a time period between each current step and its next step is a function of a distance from the start, which is a distance between the start position and a current position of the stepper motor, or a distance to target, which is a distance between the current position of the stepper motor and the commanded target position, wherein the time period is a pre-set time period multiplied by 2\hat{ }n, where n is zero or a positive integer.

16. The logic circuit of claim 15, wherein the distance from start or the distance to target is defined in step counts of the stepper motor.

17. The logic circuit of claim 16, wherein when the distance from start is less than a pre-set threshold value, n decreases as the distance to target increases, and n equals zero when the distance from start is not less than the pre-set threshold value.

18. The logic circuit of claim 17, wherein the pre-set threshold value is 2\hat{ }A, where A is a constant parameter, and when the distance from start not less than 2\hat{ }(A−n) but is less than 2\hat{ }(A−n+1), the time period is the pre-set time period multiplied by 2\hat{ }(n−1).

19. The logic circuit of claim 16, wherein n equals zero when the distance to target is not less than a pre-set threshold value, and when the distance to target is less than the pre-set threshold value, n increases as the distance to target decreases.

20. The logic circuit of claim 19, wherein the pre-set threshold value is 2\hat{ }D, where D is a constant parameter, and when the distance to target is less than 2\hat{ }(D−n) and not less than 2\hat{ }(D−n−1), the time period is the pre-set time period multiplied by 2\hat{ }(n+1).

21. The logic circuit of claim 15, wherein each time period is defined in clock cycles of the logic circuit.

22. A logic circuit for controlling a stepper motor, comprising:
a field programmable gate array (FPGA) programed to:
receive a commanded target position of the stepper motor and a pre-set time period value; and
control the stepper motor to move toward the commanded target position in a plurality of steps, including to:
(a) initialize a variable n to a value of zero;
(b) determine a current position of the stepper motor;
(c) determine a distance to target, which is a distance between the current position and the commanded target position of the stepper motor, wherein the distance to target is defined in step counts of the stepper motor;
(d) if the distance to target is not less than 2\hat{ }(D−n), where D is a constant parameter, maintain the value of n, and if the distance to target is less than 2\hat{ }(D−n), increment the value of n by 1;
(e) set a time period to a pre-set time period multiplied by 2\hat{ }n;
(f) after waiting the time period, move the stepper motor by one step; and
(g) repeat steps (b) through (f) until the commanded target position is reached.

23. The logic circuit of claim 22, wherein the time period is defined in clock cycles of the logic circuit.

24. A logic circuit for controlling a stepper motor, comprising:
a field programmable gate array (FPGA) programed to:
receive a commanded target position of the stepper motor and a pre-set time period value; and
control the stepper motor to move toward the commanded target position in a plurality of steps, including to:
(a) initialize a variable n to a value that equals A, where A is a constant parameter;
(b) determine a current position of the stepper motor;
(c) determine a distance from start, which is a distance between the start position and the current position of the stepper motor, wherein the distance from start is defined in step counts of the stepper motor;
(d) if the distance from start is not greater than 2\hat{ }(A−n), maintain the value of n, and if the distance from start is greater than 2\hat{ }(A−n), decrement the value of n by 1;
(e) set a time period to a pre-set time period multiplied by 2\hat{ }n;
(f) after waiting the time period, move the stepper motor by one step; and
(g) repeat steps (b) through (f) until n equals zero.

25. The logic circuit of claim 24, wherein the time period is defined in clock cycles of the logic circuit.
